(19) United States
(12) Patent Application Publication
(10) Pub. No.: US 2016/0150763 A1
(43) Pub. Date: Jun. 2, 2016

(54) Pet Leash System

(71) Applicants: Randy McHenry, Garden Grove, CA (US); Terri McHenry, Garden Grove, CA (US)

(72) Inventors: Randy McHenry, Garden Grove, CA (US); Terri McHenry, Garden Grove, CA (US)

(21) Appl. No.: 14/954,974

(22) Filed: Nov. 30, 2015

Related U.S. Application Data
(60) Provisional application No. 62/085,457, filed on Nov. 28, 2014.

(51) Int. Cl. A01K 27/00

(52) U.S. Cl. CPC A01K 27/004

(57) ABSTRACT

A pet leash system for simultaneously walking multiple pets is provided. The system comprises a retractable leash having a primary leash having a first end and a second end. A leash handle is secured to the first end of the primary leash with the primary leash extendable from and retractable back into the leash handle. A primary connection mechanism is secured to the second end of the leash with the primary connection mechanism releasably connectable to a first pet. A first leash having a first end and a second end is provided. A first connection mechanism is secured to the first end of the first leash with the first connection mechanism releasably connectable to the retractable leash. A second connection mechanism is secured to the second end of the first leash with the second connection mechanism releasably connectable to a second pet wherein multiple pets are controllable by the user.

### CLAIM OF PRIORITY

This patent application claims priority under 35 USC 119 (e) (1) from U.S. Provisional Patent Application Ser. No. 62/085,457 filed Nov. 28, 2014, of common inventorship herewith entitled, “Doggie Tag Along.”

### FIELD OF THE INVENTION

The present invention pertains to the field of pet accessories, and more specifically to the field of canine leashes for walking multiple dogs.

### BACKGROUND OF THE INVENTION

In a pet loving society, many pets are considered highly valued mechanisms of a family. Dogs provide unconditional love, loyalty and companionship to their owners. Known as man's best friend, dogs offer protection and are faithful and constant friends. For many owners, a favorite end to a hectic day is spent curled up on a sofa or chair with a beloved dog nestled nearby. A favorite pastime enjoyed by many dog owners, as well as their pets, is taking a leisurely or fast paced walk. Breathing in the fresh air, stretching bodies with some light exercise and enjoying the sights and sounds of new surroundings, taking an outdoor walk is a revitalizing experience for dogs and their owners.

As pleasant as a walk can be for canine and human parties, those owners who have two or more dogs often find the task of walking them at one time is a real challenge. Juggling several leashes at once results in the restraints becoming twisted and tangled together. This twisting occurs when the animals cross each other's path, resulting in their leashes becoming hopelessly tangled. Frustrating and time consuming, owners continuously stop the walk to free the snarled mess. When using multiple leashes, an owner is frequently pulled in opposite directions as dogs are attracted to various sights and smells. This constant tugging of the arms is uncomfortable for dog walkers especially while walking large breeds. Becoming tightly wrapped within the straps of the leashes is an uncomfortable experience for the dogs. As dogs become excited and active during a walk, there is a risk of the walker accidentally losing the grip on a leash and the freed pet running headlong into oncoming traffic.

The prior art has put forth several designs for canine leashes for walking multiple dogs. Among these are:

U.S. Pat. No. 8,256,385 to Cade H. Goldenberg describes a twin pet leash that prevents tangling by permitting the reel portion to rotate relative to the handle portion and contains individually controllable leash stop mechanisms. Even while an individual leash is stopped, the reel portion rotates relative to the handle portion so that tangling of the pet leashes is avoided. The leash handle portion has two triggers which are color coded to match the color of the leash, so a user readily identifies which of the two leashes are to be stopped. One or both of the leashes are stopped or released without interfering with the operation of the other leash.

US Patent 2012/0318212 to Lorena Montenegro describes a pet leash device configured primarily for pet owners or dog walkers that walk more than one dog. The pet leash device comprises a housing comprising a first and second side portions. A first leash is secured to the first side portion, a second leash is secured to the second side portion and a handle is secured to the housing. The pet leash device further comprises a rotating pivot component that secures the handle to the housing and allows the housing and the handle to rotate. A first connector is secured to an end of the first leash and a second connector is secured to an end of the second leash to secure each leash each to its respective dog's collar. The leashes are retractable within the housing. A push button controls the extension and retraction of the leashes.

US Patent 2011/0067649 to Carolyn O'Brien and John Evans describes a no tangle, retractable leash device for more than one tethered entity. The leash device includes a handle and a housing rotatably carried by the handle. The housing has an interior and at least a first and second aperture communicating the interior with the ambient environment. The device also includes at least a first and second leash reel carried within the housing. The first and second leash reels each carrying a respective leash and being independently rotatable enabling a respective leash to extend through a respective aperture of the housing. A brake inhibits the rotational movement of at least one reel.

None of these prior art references describe the present invention.

### SUMMARY OF THE INVENTION

It is an object of the present invention to provide is an attachment for a retractable dog leash configured for dog walkers to comfortably and effectively walk multiple dogs simultaneously.

The present invention is a pet leash system for simultaneously walking multiple pet. The pet leash system comprises a retractable leash having a primary leash having a first end and a second end. A leash handle is secured to the first end of the primary leash with the primary leash extendable from and retractable back into the leash handle. A primary connection mechanism is secured to the second end of the leash with the primary connection mechanism capable of being releasably connected to a first pet. A first leash having a first end and a second end is provided. A first connection mechanism is secured to the first end of the first leash with the first connection mechanism releasably connectable to the retractable leash. A second connection mechanism is secured to the second end of the first leash with the second connection mechanism capable of being releasably connected to a second pet wherein multiple pets are controllable by the user.

The present invention further includes a pet leash system for simultaneously walking multiple pets. The pet leash system comprises a retractable leash having a primary leash having a first end and a second end. A leash handle is secured to the first end of the primary leash with the primary leash extendable from and retractable back into the leash handle. A primary connection mechanism is secured to the second end of the leash, the primary connection mechanism capable of being releasably connected to a first pet. A first leash is provided having a first end and a second end. A first connection mechanism is secured to the first end of the first leash, the first connection mechanism releasably connectable to the retractable leash. A second connection mechanism is secured to the second end of the first leash with the second connection mechanism capable of being releasably connected to a second pet. A stop mechanism is releasably, slidably secured to the primary leash with the stop mechanism sized to be larger than an opening of the first connection mechanism thereby limiting the extent of movement of the first connection mechanism.

### BRIEF DESCRIPTION OF THE DRAWINGS

FIG. 1 is a perspective view illustrating the pet leash system of the present invention attached to a retractable dog leash accommodating two different sized dogs ready to go on a walk.

FIG. 2 is a close up perspective view illustrating a single handle containing a coiled, stop and release cord.

FIG. 3 is a close up perspective view illustrating the connection of the pet leash system of the present invention to a retractable dog leash to accommodate two dogs.

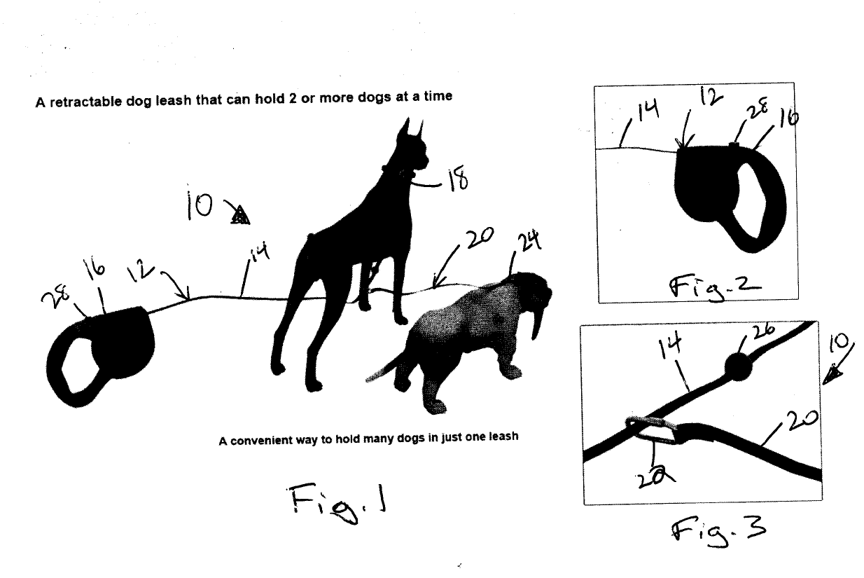

### DETAILED DESCRIPTION OF THE INVENTION

The present invention, hereinafter referred to as the pet leash system, indicated generally at 10, is an attachment to a retractable dog leash 12 configured for use with two or more dogs. The present invention provides users with a simple and comfortable means of walking multiple pets simultaneously and is designed to be used in conjunction with a retractable leash 12.

The retractable leash 12 preferably includes a primary leash 14 having a first end and a second end. A leash handle 16 is secured to the first end of the primary leash 14 with the primary leash 14 extendable from and retractable back into the leash handle 16. A primary connection mechanism 18 is secured to the second end of the primary leash 14 with the primary connection mechanism 18 capable of being releasably connected to a first pet.

The pet leash system 10 of the present invention further includes a leash 20 having a first end and a second end. A first connection mechanism 22 is secured to the first end of the leash 20 and a second connection mechanism 24 is secured to the second end of the leash 20. The first connection mechanism 22 is preferably a permanently affixed quick link having a sturdy looped holder located on the first end of the leash 22 attachable directly onto the primary leash 14 of the existing retractable leash 12. The leash 20 is attached at its first end to the primary leash 14 of the primary retractable leash 12 anywhere between the walker and the front lead dog. To secure the dog to the pet leash system 10, the second connection mechanism 24 at the second end of the leash 20 is attached to the dog's harness or collar. The first connection mechanism 22 attached to the first end of the leash 20 and/or the second connection mechanism 24 attached to the second end of the leash 20 are preferably standard quick release, clip fasteners for use in securing the leash 20 to the animal's harness or collar. It should be noted that it is within the scope of the present invention to use any type of fastener for the first connection mechanism 22 and/or the second connection mechanism 24.

Preferably, the first connection mechanism 22 and/or the second connection mechanism 24 of the leash 20 of the pet leash system 10 of the present invention are constructed of a heavy duty steel material or a comparable metal material. The leash 20 is preferably fabricated in durable nylon and measures approximately four feet in total length with a width of approximately one half inch. The second connection mechanism 24 preferably contains the same type of clip fastener 18 found on the second end of the primary leash 14.

In another embodiment, the pet leash system 10 of the present invention includes a stop mechanism 26 releasably and/or slidably secured to the primary leash 14 of the retractable leash 12. The stop mechanism 26 is sized to be larger than an opening of the first connection mechanism 22 thereby limiting the extent of movement of the first connection mechanism 22 along the length of the primary leash 14. In this manner, the user can control how close the first connection mechanism 22 gets to the primary connection mechanism 18 and, thus, the first pet.

Alternate embodiments of the pet leash system 10 of the present invention are manufactured to accommodate three and four dogs simultaneously. The pet leash system 10 is produced in a variety of sizes to for use with toy, small, medium and large breed dogs. The pet leash system 10 is produced in a wide array of colors to appeal to individual tastes.

Application and use of the pet leash system 10 of the present invention is very simple and straight forward. First, an owner or dog walker secures one dog to the primary retractable leash 12, utilizing the durable clip fastener 18 to connect the end of the primary leash 14 type of clip fastener 18 found on the second end of the primary leash 14.

In another embodiment, the pet leash system 10 of the present invention includes a stop mechanism 26 releasably and/or slidably secured to the primary leash 14 of the retractable leash 12. The stop mechanism 26 is sized to be larger than an opening of the first connection mechanism 22 thereby limiting the extent of movement of the first connection mechanism 22 along the length of the primary leash 14. In this manner, the user can control how close the first connection mechanism 22 gets to the primary connection mechanism 18 and, thus, the first pet.

Alternate embodiments of the pet leash system 10 of the present invention are manufactured to accommodate three and four dogs simultaneously. The pet leash system 10 is produced in a variety of sizes to for use with toy, small, medium and large breed dogs. The pet leash system 10 is produced in a wide array of colors to appeal to individual tastes.

Application and use of the pet leash system 10 of the present invention is very simple and straight forward. First, an owner or dog walker secures one dog to the primary retractable leash 12, utilizing the durable clip fastener 18 to connect the end of the primary leash 14 to the dog's collar or harness. The dog walker then secures the second connection mechanism 24 located on the leash 20 to the second dog's collar or harness and the first connection mechanism 22 to the primary leash 14, thus tethering the second dog to the same lead as the first dog. With both dogs secured, the dog walker embarks on a leisurely stroll or brisk walk with their beloved pooches.

The dog connected to the primary leash 14 is allotted a length of lead deemed appropriate by the dog walker by simply sliding the release mechanism 28 located on the handle 16 to permit the nylon leash 14 to be pulled freely from its spring loaded spool. Tethered to this lead or leash 20 by the sliding first connection mechanism 22, the second dog walks or trots freely beside the first dog. The second dog also is able to walk or trot back and forth along the primary lead 14 as desired. The short length and sliding component of the pet leash system 10 prevents the animals from becoming tangled while doing so. Upon returning from their walk, the dog walker simply removes pet leash system 10 and stores it until needed again.

The pet leash system 10 of the present invention enables both dogs to freely explore their surroundings while effectively preventing them from becoming hopelessly entangled while doing so. Dog walkers have greater control walking multiple dogs since there is only one handle to hold. Manufactured of durable and high quality materials, the pet leash system 10 of the present invention will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A pet leash system for simultaneously walking multiple pets, the pet leash system comprising:
a retractable leash having a primary leash having a first end and a second end;
a leash handle secured to the first end of the primary leash, the primary leash extendable from and retractable back into the leash handle;
a primary connection mechanism secured to the second end of the primary leash, the primary connection mechanism capable of being releasably connected to a first pet;
a first leash having a first end and a second end;
a first connection mechanism secured to the first end of the first leash, the first connection mechanism releasably connectable to the retractable leash; and
a second connection mechanism secured to the second end of the first leash, the second connection mechanism capable of being releasably connected to a second pet;
wherein multiple pets are controllable by the user.

2. The pet leash system of claim 1 wherein the first connection mechanism and the second connection mechanism are both a standard quick release, clip fastener.

3. The pet leash system of claim 1 wherein the first connection mechanism or the second connection mechanism is a standard clip fastener.

4. The pet leash system of claim 1 wherein the first connection mechanism and the second connection mechanism are both constructed of a heavy duty steel material.

5. The pet leash system of claim 1 wherein the first connection mechanism or the second connection mechanism is constructed of a heavy duty steel material.

6. The pet leash system of claim 1 wherein the primary leash and the first leash are both constructed from a durable nylon material.

7. The pet leash system of claim 1 wherein the primary leash or the first leash is constructed from a durable nylon material.

8. The pet leash system of claim 1 wherein the second connection mechanism is the same type of clip fastener as the primary connection mechanism.

9. The pet leash system of claim 1 and further comprising:
a stop mechanism releasably secured to the primary leash;
wherein the stop mechanism is sized to be larger than an opening of the first connection mechanism thereby limiting the extent of movement of the first connection mechanism.

10. The pet leash system of claim 1 and further comprising:
a stop mechanism slidably secured to the primary leash;
wherein the stop mechanism is sized to be larger than an opening of the first connection mechanism thereby limiting the extent of movement of the first connection mechanism.

11. The pet leash system of claim 1 and further comprising:
a second leash having a first end and a second end;
a first connection mechanism secured to the first end of the second leash, the first connection mechanism releasably connectable to the retractable leash; and
a second connection mechanism secured to the second end of the second leash, the second connection mechanism capable of being releasably connected to a third pet.

12. The pet leash system of claim 1 and further comprising:
a third leash having a first end and a second end;
a first connection mechanism secured to the first end of the third leash, the first connection mechanism releasably connectable to the retractable leash; and
a second connection mechanism secured to the second end of the third leash, the second connection mechanism capable of being releasably connected to a third pet.

13. A method for simultaneously walking multiple pets, the method comprising:
providing a retractable leash having a primary leash having a first end and a second end;
securing a leash handle to the first end of the primary leash, the primary leash extendable from and retractable back into the leash handle;
securing a primary connection mechanism to the second end of the leash;
releasably connecting the primary connection mechanism capable to a first pet;
providing a first leash having a first end and a second end;
securing a first connection mechanism to the first end of the first leash;
releasably connecting the first connection mechanism to the retractable leash;
securing a second connection mechanism to the second end of the first leash;
releasably connecting the second connection mechanism to a second pet; and
controlling multiple pets.

14. A pet leash system for simultaneously walking multiple pets, the pet leash system comprising:
a retractable leash having a primary leash having a first end and a second end;
a leash handle secured to the first end of the primary leash, the primary leash extendable from and retractable back into the leash handle;
a primary connection mechanism secured to the second end of the leash, the primary connection mechanism capable of being releasably connected to a first pet;
a first leash having a first end and a second end;
a first connection mechanism secured to the first end of the first leash, the first connection mechanism releasably connectable to the retractable leash;
a second connection mechanism secured to the second end of the first leash, the second connection mechanism capable of being releasably connected to a second pet; and
a stop mechanism releasably, slidably secured to the primary leash;
wherein the stop mechanism is sized to be larger than an opening of the first connection mechanism thereby limiting the extent of movement of the first connection mechanism; and
wherein multiple pets are controllable by the user.

15. The pet leash system of claim 14 wherein the first connection mechanism and/or the second connection mechanism are standard quick release, clip fasteners.

16. The pet leash system of claim 14 wherein the first connection mechanism and/or the second connection mechanism are constructed of a heavy duty steel material.

17. The pet leash system of claim 14 wherein the primary leash and/or the first leash are constructed from a durable nylon material.

18. The pet leash system of claim 14 wherein the second connection mechanism is the same type of clip fastener as the primary connection mechanism.

19. The pet leash system of claim 14 and further comprising:
a second leash having a first end and a second end;
a first connection mechanism secured to the first end of the second leash, the first connection mechanism releasably connectable to the retractable leash; and
a second connection mechanism secured to the second end of the second leash, the second connection mechanism capable of being releasably connected to a third pet.

20. The pet leash system of claim 14 and further comprising:
a third leash having a first end and a second end;
a first connection mechanism secured to the first end of the third leash, the first connection mechanism releasably connectable to the retractable leash; and
a second connection mechanism secured to the second end of the third leash, the second connection mechanism capable of being releasably connected to a third pet.
